(19) United States
(12) Patent Application Publication
(10) Pub. No.: US 2013/0118609 A1
(43) Pub. Date: May 16, 2013

(54) Gas flow device

(71) Applicant: Thomas Neil Horsky, Boxborough, MA (US)

(72) Inventor: Thomas Neil Horsky, Boxborough, MA (US)

(21) Appl. No.: 13/694,067

(22) Filed: Oct. 25, 2012

Related U.S. Application Data
(60) Provisional application No. 61/629,058, filed on Nov. 12, 2011.

(51) Int. Cl. F17D 1/04

(52) U.S. Cl. 137/505

(57) ABSTRACT

The invention described herein pertains to an improved method of controlling the flow of gases into a process chamber. The method incorporates a gas source, one or more pressure reduction stages, a throttle valve, a pressure gauge, and a control system. When connected to a process chamber held at sub-atmospheric pressure, the invention provides a steady flow of gas such that the stability of said flow is superior to many commercially available metering devices, such as thermally-based mass flow controllers.

### CROSS REFERENCE TO RELATED APPLICATIONS

This application claims priority to and the benefit of U.S. Provisional Patent Application No. 61/629,058, filed on Nov. 12, 2011, entitled Gas Flow Device.

### TECHNICAL FIELD AND INDUSTRY APPLICABILITY OF THE INVENTION

This invention is useful in controlling the flow of gases from a gas cylinder to a vacuum chamber where a gas-based process may occur, for example, in the manufacture of semiconductor devices, the creation of thin film coatings, and in various chemical manufacturing processes.

### BACKGROUND OF THE INVENTION

Many of the processes used in the manufacturing of integrated circuits are performed at sub-atmospheric pressures in dedicated systems called process chambers. These systems typically incorporate vacuum pumps to maintain a desired process pressure range under a gas load, and are coupled to a gas distribution system which supplies the gaseous chemicals required for specific processes. Such processes include deposition (CVD, PECVD, LPCVD, ALD, or PVD, for example) or ion implantation (beam line ion implantation, plasma doping ion implantation, or plasma immersion ion implantation). Gaseous chemicals are typically stored in super-atmospheric pressure cylinders, each cylinder having a dedicated pressure regulator. In certain cases, cylinders may be at sub-atmospheric pressure (as in so-called Safe Delivery System® products). Additionally, certain materials, such as organo-metallic compounds, may be sublimated or otherwise gasified from either solid or liquid materials.

Gases are typically fed into a gas distribution manifold for communication to a specific process chamber or chambers on demand. This manifold is connected to one or more outlets which contain metering valves to control the flow of gaseous material to its point of use. The characteristics of this metering valve largely determines the instantaneous downstream pressure of the process chamber. An ideal gas metering technology would enable process pressure accuracy (match of actual process pressure to user set point value), repeatability, stability, and fast response to fluctuations in upstream pressure, also an important aspect of stability.

The most common type of metering valve for many applications is the mass flow controller (MFC). MFC's are readily available in multiple flow ranges, are relatively inexpensive, and have a small footprint. Conventional MFC's regulate flow by measuring the heat transferred to a volume of gas by a heater element; they are therefore calibrated for the heat capacity of a specific gas. This technology has certain inherent limitations, particularly for low flow (e.g., 0.2 sccm to 10 sccm) and low process pressure (e.g., 0.1 milliTorr to 100 milliTorr) applications, in that it is subject to drift, and is inherently slow, so that thermally-based MFC's cannot properly adapt to fast transients in inlet pressure. Therefore, a need exists for an improved gas flow device with fast transient response and improved stability.

### BRIEF SUMMARY OF THE INVENTION

The invention described herein pertains to an improved method of controlling the flow of gases into a process chamber. The method incorporates a gas source, one or more pressure reduction devices, a throttle valve, a pressure gauge, and a control system. When connected to a process chamber held at sub-atmospheric pressure, the invention provides a steady flow of gas such that the stability of said flow is superior to many commercially available flow control devices.

The invention provides means to establish a well-defined pressure at the inlet of a process chamber which is actively pumped. The pressure within the process chamber is then determined by the fixed conductance of said inlet and the pumping speed of the pump, that is, there is a one-to-one correlation between inlet pressure and process chamber pressure. Thus, pressure instabilities in the process chamber will be minimized if the inlet pressure is stable. Conversely, if inlet pressure is not stable, the process chamber pressure will likely not be stable. The goal of this invention is therefore to produce a stable inlet pressure.

In one embodiment, shown in FIG. 1, a gas source (shown surrounded by a dotted box) produces a regulated flow of gas at a delivery pressure P1 on the order of 5 psig as is common in the industry for high-pressure cylinders having one- or two-stage regulators. Downstream of the regulator, the pressure is reduced further to a pressure P2 by pressure reduction device C1, which is a conductance limitation. Depending on how C1 is configured, P2 may be between 1 Torr and 100 Torr, for example. C1 may be a long, narrow pipe (illustrated as a ‘loop’ in FIG. 1) which has a fixed conductance. Other embodiments may include a variable conductance C1 (such as a variable-conductance valve); however, the intent of FIG. 1 is to illustrate the basic concept of the novel flow control device. Downstream of P2 is an electrically-adjustable metering or throttle valve V2. V2 is selected to be a high-conductance valve having a dynamic range of between 3 and 100, for example; that is, when in a flow condition, V2 will reduce P2 by between 3 and 100 times to a pressure P3. Downstream of V2 is pressure gauge G3. G3 is selected to measure pressure P3 with excellent reproducibility and low signal-to-noise ratio. Thus, G3 can be selected to provide optimized performance for the useful pressure range of P3. This is of note since gauges are typically configured to operate best within a given pressure range. The output of G3 is interpreted by a control system to adjust the conductance of V2, as described below.

Downstream of G3 may be a fixed conductance C2. C2 couples directly to the inlet conductance C of the process chamber. Thus, the novel gas flow device is comprised of the assembly of elements C1, V2, G3, C2, and a control system, as illustrated in FIG. 2.

By selecting appropriate values of conductances C1 and C2, a broad range of process chamber pressures can be produced. Thus, we define four pressure values:
P1: Delivery pressure of regulated gas source
P2: Pressure downstream of pressure reducer C1
P3: Pressure downstream of V2
P4: Inlet pressure to process chamber conductance C, downstream of pressure reducer C2
P5: process chamber pressure.

A goal of this invention is to produce a stable and well-defined pressure P3. This is accomplished through closed-loop control of throttle valve V2 by downstream pressure gauge G3, in the following manner:
1. A set point for P3 (as measured by G3) is selected by the user
2. The output signal of G3 is fed into a control circuit which compares this signal with the user set point
3. Said circuit produces an error signal which is directed to V2 to adjust its position such that the magnitude of said error signal is minimized.
   This control methodology requires that V2 be electrically adjustable, for example by an electric motor which moves a throttling element of V2 which determines the conductance of V2. Such throttle valves with position control that closes the loop on the output of a pressure gauge are commercially available, for example, a butterfly valve available from MKS Instruments, North Andover, MA. Other types of throttle valves such as pendulum valves, linear gate valves, and others are also commercially available.

Once the delivery pressure from the gas source P1 and the desired process chamber pressure P5 are given, and the actively pumped process chamber inlet conductance C and the volumetric flow of process gas Q is known, then the appropriate pressure value of P2, and the pressure ranges of P3 and P4 can be calculated. These calculations will determine the appropriate values of C1 and C2. C1 and C2 can be readily tailored for different ranges of P1 and P5, so that the same basic flow control architecture can be preserved for a number discrete pressure ranges. That is, C1 is selected to adjust the (static) gas source pressure, while C2 is selected to adjust the (static) inlet pressure to the process chamber. The dynamic range of the novel gas flow device is therefore determined by the dynamic range of V2. We note that we can choose high values of C1 or C2 (i.e., as though there were no pressure reducers C1 or C2) if conditions so demand. A given set of values C1 and C2 simply determine the dynamic range of pressure delivered to conductance C of the process chamber, P4.

The following examples serve to illustrate the utility of the invention, and are not meant to provide exact values for the several variables discussed. The effects of turbulence, viscous versus molecular flow, and transitions between flow regimes will depend on the properties and geometries of the components which are selected to perform the described functions of C1, C2, V2, and indeed how they are physically coupled.

Example 1: An implanter ion source receiving a volumetric flow of process gas of 2 sccm at an ion source pressure of 1 mTorr. The gas inlet to the ion source is a long thin pipe with a conductance C of 5×10⁻² L/s. Gas source is high-pressure cylinder regulated down to 5 psig.
P1: 5 psig
P5: 1 mTorr
C: 5×10⁻² L/s
Q: 2 sccm=2.5×10⁻² Torr-L/s.
   We use the relation

C=Q/(P4−P5) (1)

to determine P4 from a known C and Q. Thus,

P4=Q/C+P5. (2)

For such a small conductance C, the pressure drop is substantial, so that P5<<P4. Thus,

P4˜Q/C. (3)

Therefore, P4 is about 0.5 Torr. Choosing a finite value of C2 will only serve to increase the operating pressure of V2. For this example, assume that C2 is large, so that P3˜P4. This embodiment is shown in FIG. 3 as embodiment 2; C2 is absent, and the outlet of V2 couples directly to C.

If V2 is a throttle valve with a useful dynamic range of 20, then P2 (the inlet pressure to V2) can be between about 10 Torr and 0.5 Torr. This range is somewhat dependent on the finite conductance of V2 in its fully open position, but we note that in practice, the conductance dynamic range of V2 can be accurately measured.

With the range of P2 thus defined, C1 is required to reduce the pressure from 5 psig (approximately 1000 Torr) to approximately 5 Torr (the middle of V2's useful control range for P2). This factor of 200 in pressure reduction can be accomplished by either a variable-conductance valve, for example if adjustability is required, or a fixed pressure reducer, such as a long thin pipe as shown in FIG. 3, or indeed a round pipe with entrance and exit apertures, as shown in FIG. 6.

Using the form of Equation (1), we find that the required conductance for C1 is:

C1=Q/(P1−P2). (4)

Inserting the values Q=2.5×10⁻² Torr-L/s, P1=1000 Torr, and P2=5 Torr, we have

C1˜2.5×10⁻⁵ L/s. (5)

Example 2: Implanter ion source receiving a volumetric flow of process gas of 0.2 sccm with ion source pressure of 1 mTorr. The gas inlet to the source is a long thin pipe with a conductance of 5×10⁻² L/s. Gas source is sub-atmospheric gas cylinder providing a delivery pressure of 500 Torr.
P1: 500 Torr
P5: 1 mTorr
C: 5×10⁻² L/s
Q: 0.2 sccm=2.5×10⁻³ Torr-L/s.

This example is similar to Example 1 except for the sub-atmospheric delivery pressure of the gas source and the volumetric flow, so we will use embodiment 2 of FIG. 3. Following the same method of calculation, we find:

P4=P3˜Q/C (6)

P3=50 mTorr. (7)

If V2 is a throttle valve with a useful dynamic range of 20, then P2 can be between about 1 Torr and 50 mTorr. Thus, we choose P2 to be centered about the useful range of V2:

P2=0.5 Torr. (8)

Again using Equation (1), we find that the required conductance for C1 is:

C1=Q/(P1−P2). (9)

Inserting the values Q=2.5×10⁻³ Torr-L/s, P1=500 Torr, and P2=0.5 Torr, we have

C1˜5×10⁻⁶ L/s. (10)

Example 3: An alternative solution to example 2 can be realized by using embodiment 1 to insert a finite conductance between throttle valve V2 and chamber conductance C, which raises the required inlet pressure P2 calculated in example 2 above. From example 2 above, we have:
P1: 500 Torr
P4: 50 mTorr
P5: 1 mTorr
C: 5×10⁻² L/s
Q: 0.2 sccm=2.5×10⁻³ Torr-L/s.
   For example, we can choose

C2=1×10⁻⁴ L/s, (11)

### Yielding

P3=25 Torr. (12)

Thus, V2 can operate from about 25 Torr to about 500 Torr. Selecting the approximate midpoint of this pressure range,

P2=250 Torr. (13)

To calculate the required conductance C1 between the gas source and V2,

C1=Q/(P1−P2). (14)

Inserting these values yields

C1=1×10⁻⁵ L/s. (15)

Thus, we see that in this example, incorporating a finite conductance C2<C increases the required conductance of C1.

Example 4: Process chamber receiving a volumetric flow of process gas of 100 sccm at a process pressure of 100 mTorr. The process chamber gas inlet has a conductance of 0.5 L/s.
P1: 5 psig
P5: 100 mTorr
C: 0.5 L/s
Q: 100 sccm=1.3 Torr-L/s
   Using the same approach as used in example 1, we use embodiment 2; that is, we set

P3=P4. (16)

We calculate the expected values of P3, P2, and C1:

From Eq. (2), P3=Q/C+P5.

Substituting the values above,

P3=2.7 Torr. (16)

If we select a throttle valve V2 with a dynamic range of at least 20, then P2 should be in the approximate range 2 Torr to 40 Torr. With the range of P2 thus defined, V1 is required to reduce the pressure from 5 psig (approximately 1000 Torr) to approximately 20 Torr (in the middle of the useful control range for P2). This factor of 50 in pressure reduction can be accomplished by either a variable-conductance valve, for example if adjustability is required, or a fixed pressure reducer, such as a round pipe with entrance and exit apertures, as shown in FIG. 6, or a long thin tube, for example. Again using Equation (1), we find that the required conductance for V1 is:

C1=Q/(P1−P2). (18)

Inserting the values Q=1.3 Torr-L/s, P2=20 Torr, and P1=1000 Torr, we have

C1˜1.3×10⁻³L/s. (19)

### BRIEF DESCRIPTION OF THE DRAWINGS

These and other advantages of the present invention will be readily understood with reference to the following specification and attached drawing wherein:

FIG. 1: System diagram with embodiment 1 of gas flow device coupled between a regulated gas source and a process chamber.

FIG. 2: Ion source for an ion implanter.

FIG. 3: Embodiment 1 of gas flow device, wherein C1 and C2 are limiting conductances having fixed values.

FIG. 4: Embodiment 2 of gas flow device, wherein C1 has a fixed conductance value and C2 is absent.

FIG. 5: Embodiment 3 of gas flow device, wherein C1 is replaced by a variable conductance V1, and C2 is a fixed conductance.

FIG. 6: Alternative form of FIG. 3, wherein C1 is a labyrinth type conductance limitation containing baffles.

### DETAILED DESCRIPTION OF THE INVENTION

The invention described herein pertains to an improved method of controlling the flow of gases into a process chamber. The method incorporates a gas source, one or more pressure reduction devices, a throttle valve, a pressure gauge, and a control system. When connected to a process chamber held at sub-atmospheric pressure, the invention provides a steady flow of gas such that the stability of said flow is superior to many commercially available flow control devices.

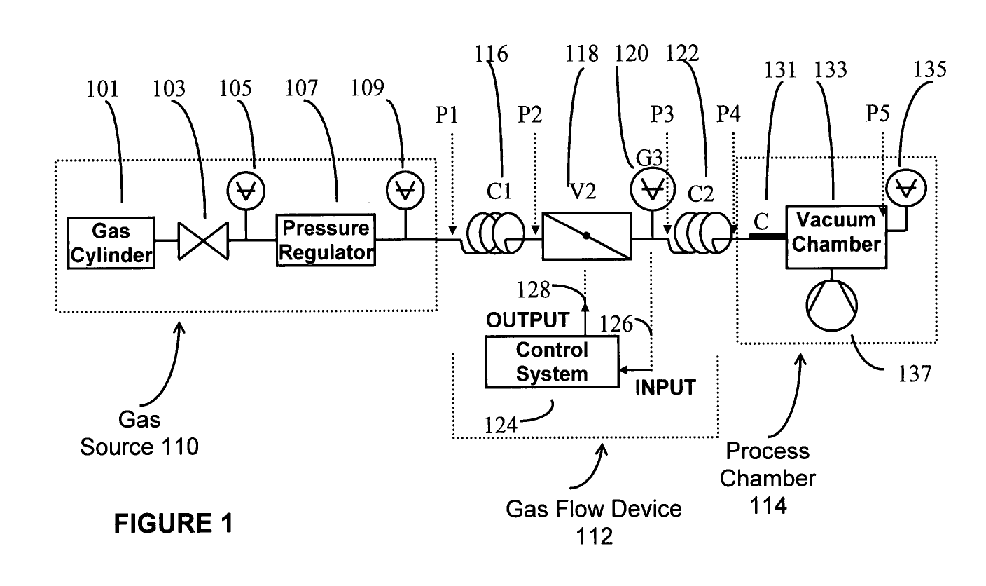

Referring now to FIG. 1, a gas source 110 provides a regulated gas pressure P1 to the downstream system. Gas source 110 can be provided in many different configurations; however, for clarity, we describe a high pressure cylinder 101 followed by a shutoff valve 103 and pressure gauge 105. Downstream of gauge 105 is a pressure regulator 107 which regulates pressure from cylinder pressure to about 5 psig, as is common in the semiconductor equipment industry. The outlet pressure of regulator 107 is a gauge 109, which reports the pressure P1 at the outlet of regulator 107.

Also now referring to FIG. 1, downstream of gas source 110 is the novel gas flow device 112. The purpose of gas flow device 112 is to provide a variable but stable pressure P4 at its outlet. Gas flow device 112 is comprised of conductance limitation C1 116, throttle valve V2 118, pressure gauge G3 120, conductance limitation C2 122, and control system 124. This is a general embodiment, wherein the several components can be of a number of different types. Throttle valve V2 118 can be any dynamically adjustable and electrically controllable valve, such as a butterfly valve, pendulum valve, or linear gate valve, for example. Conductances C1 116 and C2 122 can have one of many different constructions, such as long thin tubes, baffles, apertures, or a combination thereof, for example.

Downstream of gas source 110, pressure P1 is further reduced to a pressure P2 by pressure reduction device C1 116. Depending on how C1 116 is configured, P2 may be between 1 Torr and 100 Torr, for example. Downstream of P2 is an electrically-adjustable metering or throttle valve V2 118. V2 118 is selected to be a high-conductance valve having a dynamic range of between 3 and 100, for example; that is, when in a flow condition, V2 118 will reduce P2 by between 3 and 100 times to a pressure P3. Downstream of V2 118 is a pressure gauge G3 120. G3 120 is selected to measure pressure P3 with excellent reproducibility and low signal-to-noise ratio.

Thus, G3 120 can be selected to provide optimized performance for the useful pressure range of P3. The output signal of G3 120 is interpreted by control system 124 to adjust the conductance of V2 118, as further described below:
1. A set point for P3 (as measured by G3 120) is selected by the user
2. The output signal of G3 120 is fed into the input 126 of control system 124 which compares input 126 with user set point value
3. Said control system 124 then produces an error signal, which then generates an output 128 directed to V2 to adjust its position such that the magnitude of said error signal is minimized.
   This control methodology requires that V2 118 be electrically adjustable, for example by an electric motor which moves a throttling element of V2 118 which determines the conductance of V2 118.

The output of gas flow device 112 establishes a pressure P4 at the inlet of a process chamber 114. The process chamber can be one of various configurations, and in FIG. 1 a set of basic elements provided in virtually any process chamber are shown. The process chamber inlet conductance C 131 is directly coupled to vacuum chamber 133, typically a vacuum chamber wherein a particular process is said to occur; vacuum chamber 133 is connected to vacuum pump 137, and the pressure within said vacuum chamber 133 is monitored by vacuum gauge 135. In many cases, a wafer or substrate is inserted into vacuum chamber 133 and gases are introduced in desired combinations to allow a specific process to be applied to the substrate or wafer. These processes are typically conducted at sub-atmospheric pressure (i.e., less than 760 Torr), and in many cases, may occur at pressures below 10 Torr, below 1 Torr, or in certain cases below 1 milliTorr. Some common vacuum-based processes include deposition (CVD, PECVD, LPCVD, ALD, or PVD, for example) or ion implantation (beam line ion implantation, plasma doping ion implantation, or plasma immersion ion implantation). Gaseous chemicals are typically stored in super-atmospheric pressure cylinders, each having a dedicated pressure regulator. In certain cases, cylinders may be at sub-atmospheric pressure (as in so-called Safe Delivery System® products). Without loss of generality, FIG. 1 can be interpreted such that several gas sources 110 can each be coupled to individual gas flow devices 112 which then provide user-selected flows to a gas manifold (not shown in FIG. 1), which is then connected to process chamber conductance C 131 to provide the desired gas mixtures to process chamber 114.

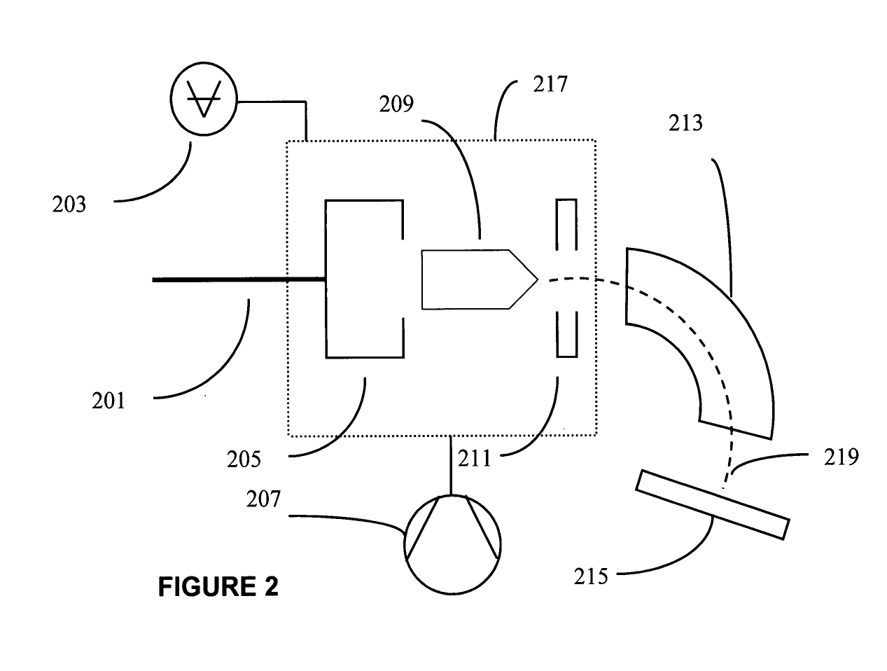

In certain cases, said process chamber 114 is a plasma chamber, and the substrate or wafer to be processed is located elsewhere. The plasma from said process chamber 114 may be communicated to a vacuum chamber located elsewhere, which contains the wafers or substrates to be processed. Such a case includes a beam line ion implanter, wherein said vacuum chamber 133 includes an ion source, as shown in FIG. 2. In an ion implanter, one or more gases at individual pressures P4 may flow through conductance C 131 to the ionization chamber of an ion source, shown in FIG. 2. Referring now to FIG. 2, gases flow from the gas flow device or a manifold through conductance 201 and into ionization chamber 205. The gases are formed into a plasma within ionization chamber 205 and positive ions 209 from said plasma are extracted from ionization chamber 205 by an extraction electrode 211. Elements 205, 209, and 211 are enclosed within a vacuum chamber 217 which is held at high vacuum (below 1×10⁻⁴ Torr) by vacuum pump 207 and said vacuum is monitored by vacuum gauge 203. Ion source ionization chamber 205 is typically held at a high positive voltage (between 100V and 100 kV) relative to extraction electrode 211 and vacuum chamber 217, so that the ions are extracted and formed into an ion beam 219 by strong electric fields. The ion beam 219 is then transported to a wafer or substrate 215 by the magnetic fields produced by a transport electromagnet 213. Elements 213, 219, and 215 also held at a high vacuum level similar to that of vacuum chamber 217, although the additional vacuum system elements such as pumps and chambers are not shown in FIG. 2.

Typically, transport magnet 213 disperses ion beam 219 according to the mass-to-charge ratio of the ions, such that unwanted ions can be prevented from reaching the wafer or substrate 215 by a simple aperture plate located between transport magnet 213 and wafer or substrate 215.

The gas pressure within ionization chamber 205 is typically between 0.1 mTorr and 10 mTorr, depending on the type of ion source used by the ion implanter. In certain cases, however, the pressure may be substantially higher or lower. Although the pressure within the ionization chamber 205 of the ion source is in the milliTorr range, the pressure within the surrounding vacuum chamber 217 is typically at least an order of magnitude lower. This reduced pressure is meant to preserve the ion beam during transport, and also to maintain high electric fields without unwanted electrical discharges.

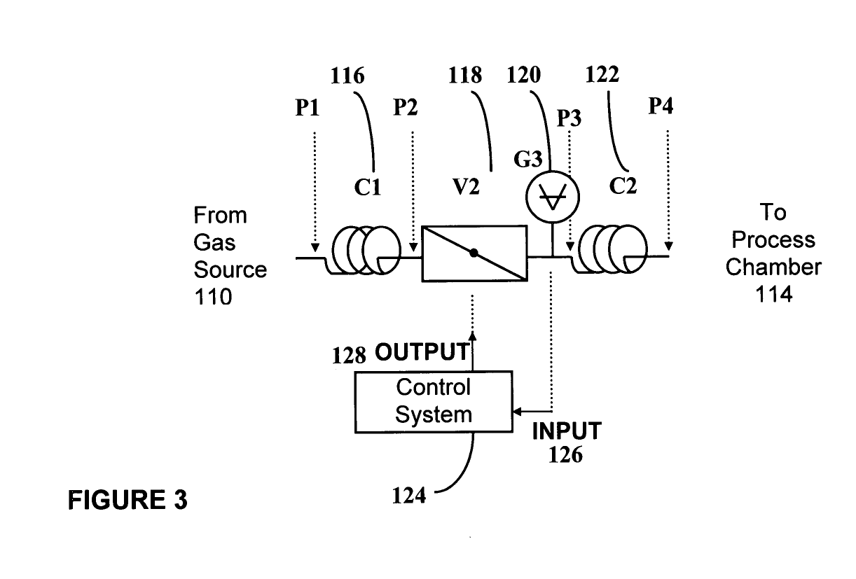

FIG. 3 shows embodiment 1 of the gas flow device used in FIG. 1. Gas flow device 112 is comprised of conductance limitation C1 116, throttle valve V2 118, pressure gauge G3 120, conductance limitation C2 122, and control system 124 having input 126 and output 128. This is the embodiment used in Example 3 given above.

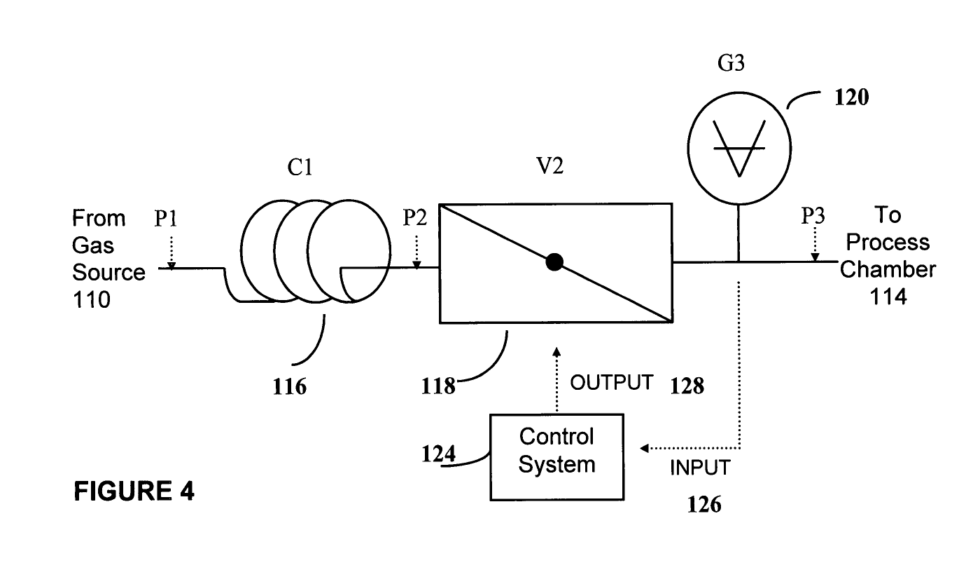

FIG. 4 illustrates embodiment 2 of the novel gas flow device. It is identical to the design of embodiment 1, except there is no limiting conductance C2 122 between throttle valve V2 118 and process chamber conductance C 131. This is the embodiment used in Example 1 and Example 2 described above.

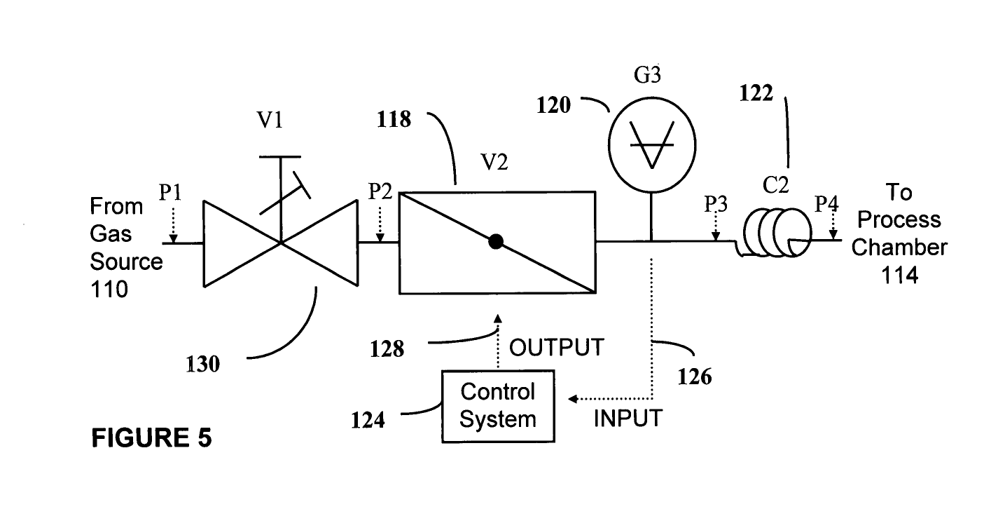

FIG. 5 shows embodiment 3 of the gas flow device. Embodiment 3 differs from the previous embodiments in that limiting fixed conductance C1 116 between gas source 110 and throttle valve V2 118 is now a variable-conductance valve V1 130, such as a needle valve, ball valve or other type of metering valve. This provides flexibility to accommodate a broader range of gas source pressures P1 than does a fixed conductance.

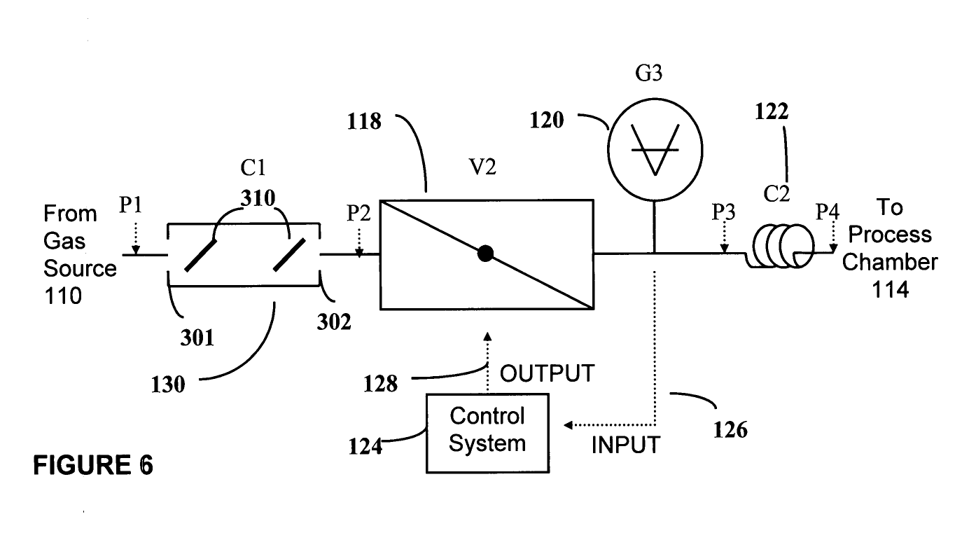

FIG. 6 shows an alternate form of embodiment 1 of the novel gas flow device. C1 130, the limiting conductance between gas source 110 and throttle valve V2 118 is shown as a long tube having inlet aperture 301 and exit aperture 302, and interior baffles 310, in order to illustrate that a conductance-limiting element can incorporate many types of geometric forms, in addition to the long, thin tube or loop pictured as C1 116 in embodiments 1 and 2.

Other forms of this invention are possible, and the embodiments described herein are intended to explain the basic operating principles and utility of the invention, but do not preclude other embodiments not described.

What is claimed and desired to be covered by a Letters Patent is as follows:

What is claimed is:

1. A gas flow device useful for controlling the rate of flow of gases into a process chamber, said gas flow device comprising:
An electrically-controlled throttle valve,
a pressure gauge,
a control system, and
two fixed-value conductance elements C1 and C2, wherein their individual conductance values are configurable to accommodate a particular inlet gas pressure range and a desired process chamber pressure range.

2. The gas flow device of claim 1, wherein said control system is configured to receive an input signal from said pressure gauge, and to provide an output signal to said throttle valve, said output signal determining the throttling position of said throttle valve.

3. The gas flow device of claim 1, wherein said fixed conductance C1 is selected to accommodate a particular gas inlet pressure range, and said fixed conductance C2 is selected to accommodate a particular desired process chamber pressure range.

4. The gas flow device of claims 1, wherein said fixed conductance elements C1 and C2 are demountable from the gas flow device assembly, and may be replaced with elements having different individual conductance values.

5. The gas flow device of claim 1, wherein said throttle valve is a butterfly valve, and the position of said butterfly determines the gas conductance of said butterfly valve.

6. The gas flow device of claim 1, wherein said throttle valve is a metering valve, the setting of said metering valve determining the gas conductance of said metering valve.

7. A gas flow device useful for controlling the rate of flow of gases into a process chamber, said gas flow device comprising:
An electrically-controlled throttle valve,
a pressure gauge,
a control system, and
a variable conductance element C1 and a fixed conductance element C2 in which the conductance values thereof are configurable to accommodate a particular inlet gas pressure range and a desired process chamber pressure range.

8. The gas flow device of claim 7, wherein said control system is configured to receive an input signal from said pressure gauge, and to provide an output signal to said throttle valve, said output signal determining the throttling position of said throttle valve.

9. The gas flow device of claim 7, wherein said variable conductance element C1 is selected to accommodate a particular gas inlet pressure range, and said fixed conductance element C2 is selected to accommodate a particular desired process chamber pressure range.

10. The gas flow device of claim 7, wherein said conductance elements C1 and C2 are demountable from the gas flow device assembly, and can be replaced with conductance elements having different conductance values, whether fixed or variable.

11. The gas flow device of claim 7, wherein said throttle valve is a butterfly valve, and the position of said butterfly determines the gas conductance of said butterfly valve.

12. The gas flow device of claim 7, wherein said throttle valve is a metering valve, the setting of said metering valve determining the gas conductance of said metering valve.

13. A gas flow device useful for controlling the rate of flow of gases into a process chamber, said gas flow device comprising:
An electrically-controlled throttle valve,
a pressure gauge,
a control system, and
a conductance-limiting element C1 in which the conductance value thereof is selected to accommodate a particular inlet gas pressure range and a desired process chamber pressure range.

14. The gas flow device of claim 13, wherein said control system is configured to receive an input signal from said pressure gauge, and to provide an output signal to said throttle valve, said output signal determining the throttling position of said throttle valve.

15. The gas flow device of claim 13, wherein said conductance element C1 is demountable from the gas flow device assembly, and may be replaced with a conductance-limiting element having a different conductance value or a different variable conductance range.

16. The gas flow device of claim 13, wherein conductance element C1 has a fixed conductance.

17. The gas flow device of claim 13, wherein conductance element C1 has a variable conductance.

18. The gas flow device of claim 13, wherein said throttle valve is a butterfly valve, and the position of said butterfly determines the gas conductance of said butterfly valve.

19. The gas flow device of claim 13, wherein said throttle valve is a metering valve, the setting of said metering valve determining the gas conductance of said metering valve.
